(19) United States
(12) Patent Application Publication
(10) Pub. No.: US 2025/0310196 A1
(43) Pub. Date: Oct. 2, 2025

(54) METHOD AND APPARATUS FOR MANAGING NETWORK FUNCTIONS BY CONSIDERING ENERGY USAGE IN WIRELESS COMMUNICATION SYSTEM

(71) Applicant: Samsung Electronics Co., Ltd., Suwon-si (KR)

(72) Inventors: Dongeun SUH, Suwon-si (KR); Dongyeon KIM, Suwon-si (KR); Jungshin PARK, Suwon-si (KR); Hoyeon LEE, Suwon-si (KR)

(21) Appl. No.: 19/097,175

(22) Filed: Apr. 1, 2025

(30) Foreign Application Priority Data
Apr. 1, 2024 (KR) 10-2024-0044375

(51) Int. Cl. H04L 41/0833

(52) U.S. Cl. CPC H04L 41/0833

(57) ABSTRACT

Provided is a method performed by a consumer network function (NF) in a wireless communication system, the method including transmitting, to a network function energy control function (NECF), a request message for energy related information about at least one NF instance, receiving, from the NECF, a response message including the energy related information about the at least one NF instance corresponding to a target NF, and performing energy-aware NF selection based on the received energy related information.

### CROSS-REFERENCE TO RELATED APPLICATION(S)

This application is based on and claims priority under 35 U.S.C. § 119(a) of a Korean patent application number 10-2024-0044375, filed on Apr. 1, 2024, in the Korean Intellectual Property Office, the disclosure of which is incorporated by reference herein in its entirety.

### BACKGROUND

### 1. Field

The disclosure relates to a method and apparatus for managing network functions by considering energy usage in a wireless communication system.

### 2. Description of the Related Art

Efforts have been made to develop an improved 5th generation (5G) communication system or pre-5G communication system to meet the growing demand for wireless data traffic after the commercialization of 4th generation (4G) communication systems. For this reason, the 5G or pre-5G communication system is referred to as a beyond 4G network communication system or a post long-term evolution (LTE) system. Implementation of 5G communication systems in an ultra-high frequency (millimeter-wave (mmWave)) band (such as a 60 gigahertz (GHz) band) is under consideration to achieve high data transfer rates. To mitigate path loss of radio waves and increase transmission distance of radio waves in an ultra-high frequency band, beamforming, massive multiple-input multiple-output (MIMO), full dimensional MIMO (FD-MIMO), array antennas, analog beamforming, and large-scale antenna technologies are being discussed for 5G communication systems. Furthermore, to improve system networks for 5G communication systems, technologies such as evolved small cells, advanced small cells, cloud radio access network (RAN), ultra-dense networks, device to device (D2D) communication, wireless backhaul, moving networks, cooperative communication, coordinated multi-points (COMP), and received-interference cancellation have been developed. In addition, for 5G systems, advanced coding modulation (ACM) schemes, such as hybrid frequency shift keying (FSK) and quadrature amplitude modulation (QAM) (FQAM) and sliding-window superposition coding (SWSC), and advanced access techniques, such as filter bank multicarrier (FBMC), non-orthogonal multiple access (NOMA), sparse code multiple access (SCMA), etc. have been developed.

Moreover, the Internet has evolved from a human-centered connection network, in which humans create and consume information, to the internet of things (IoT) network in which dispersed components such as objects exchange information with one another to process the information. Internet of everything (IoE) technology has emerged, in which the IoT technology is combined with, for example, technology for processing big data through connection with a cloud server, etc. To implement the IoT, technologies such as sensing technology, wired/wireless communication and network infrastructure, service interface technology, and security technology are required, and thus, research has recently been conducted into technologies such as sensor networks, machine to machine (M2M) communication, and machine type communication (MTC) for interconnecting objects. In an IoT environment, intelligent information technology (IT) services may be provided to create new values for human life by collecting and analyzing data generated from interconnected objects. The IoT may be applied to fields such as smart homes, smart buildings, smart cities, smart cars or connected cars, smart grids, healthcare, smart home appliances, advanced medical services, etc., through convergence and integration between existing IT technologies and various industries.

Thus, various attempts are being made to apply a 5G communication system to the IoT network. For example, technologies such as sensor networks, M2M communication, MTC, etc., are implemented using 5G communication techniques such as beamforming, MIMO, array antennas, etc. The application of a cloud RAN as the above-described big data processing technology may be also an example of convergence between the 5G and IoT technologies.

In addition, efforts are being made to develop 6th generation (6G) communication systems that are about five times faster than the maximum speed of 5G. Accordingly, implementation in a higher frequency band than for 5G is being considered to achieve higher data rates.

As various services may be provided as a result of the advancements in wireless communication systems as described above, in particular, a method of managing network functions with consideration of energy usage is required.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for managing network functions by considering energy usage in a wireless communication system or mobile communication system.

Additional aspects will be set forth in part in the description which follows and, in part, will be apparent from the description, or may be learned by practice of the presented embodiments.

In accordance with an aspect of the disclosure, an operation method of a network repository function (NRF) in a wireless communication system is provided. The operation method includes receiving a network function (NF) registration request message from at least one NF, receiving, from a consumer NF, an NF status subscription request message requesting subscription to an NF status of at least one target NF, transmitting, to a network function energy control function (NECF), an energy related information request message for the at least one target NF, receiving, in response to the energy related information request message, from the NECF, a notification message including energy related information about the at least one target NF, updating an NF profile for the at least one target NF, transmitting an NF status change notification message to the at least one target NF, receiving a status change response message from the at least one target NF, and transmitting an NF profile update notification message to the consumer NF.

In accordance with an aspect of the disclosure, a method performed by a consumer network function (NF) in a wireless communication system is provided. The method includes transmitting, to a network function energy control function (NECF), a request message for energy related information about at least one NF instance, receiving, from the NECF, a response message including the energy related information about the at least one NF instance corresponding to a target NF, and performing energy-aware NF selection based on the received energy related information.

In accordance with an aspect of the disclosure, a method performed by a network function energy control function (NECF) in a wireless communication system is provided. The method includes receiving, from a consumer network function (NF), a request message for energy related information about at least one NF instance, collecting the energy related information about the at least one NF instance based on the request message, and transmitting, to the consumer NF, a response message including the energy related information about the at least one NF instance corresponding to a target NF.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an architecture of a 5th generation (5G) system according to an embodiment of the disclosure;

FIG. 2 illustrates a method of updating a network function (NF) status or NF priority based on energy information, according to an embodiment of the disclosure;

FIG. 3 illustrates an NF-based method of updating an NF status based on energy information, according to an embodiment of the disclosure;

FIG. 4 illustrates a consumer NF-based method of determining an NF status or NF priority based on energy information, according to an embodiment of the disclosure; and

FIG. 5 is a diagram illustrating a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b, or c” indicates only a, only b, only c, both a and b, both a and c, both b and c, all of a, b, and c, or variations thereof.

Throughout the specification, a layer may also be referred to as an entity.

In the following description of embodiments of the disclosure, descriptions of technical features that are well known in the art to which the disclosure pertains and are not directly related to the disclosure are omitted. This is for clearly describing the essence of the disclosure without obscuring it by omitting the unnecessary descriptions.

Advantages and features of the disclosure and methods of accomplishing the same will be more readily appreciated by referring to the following description of embodiments of the disclosure and the accompanying drawings. However, the disclosure may be embodied in many different forms and should not be construed as being limited to embodiments of the disclosure set forth below.

As used in the following description, terms identifying access nodes, terms indicating network entities, terms indicating messages, terms indicating interfaces between network entities, terms indicating various types of identification information, etc. are exemplified for convenience of description. Accordingly, the disclosure is not limited to terms described below, and other terms representing objects having equivalent technical meaning may be used.

Hereinafter, for convenience of description, the disclosure uses terms and names defined in the 3rd Generation Partnership Project New Radio (3GPP NR) standard. However, the disclosure is not limited by the terms and names but may also be equally applied to systems that comply with other standards. As used herein, a base station may represent a next-generation Node B (gNB). Furthermore, the term ‘terminal’ (also referred to as user equipment (UE)) may refer to mobile phones, narrowband internet of things (NB-IoT) devices, sensors, and other wireless communication devices.

Hereinafter, a base station is an entity that allocates resources to a terminal, and may be at least one of a gNodeB (or gNB), an evolved Node B (eNode B or eNB), a Node B, a base station (or BS), a radio access unit, a base station controller, or a network node. A terminal may include a UE, a mobile station (MS), a cellular phone, a smart phone, a computer, or a multimedia system capable of performing a communication function. However, the base station and the terminal are not limited to the above examples.

In particular, the disclosure may be applied to the 3GPP NR standard (the 5th generation (5G) mobile communications standard). Furthermore, the disclosure may be applied to intelligent services (e.g., smart homes, smart buildings, smart cities, smart cars or connected cars, health care, digital education, retail businesses, security and safety related services, etc.) based on the 5G communication technology and IoT related technology.

Wireless communication systems have progressed beyond providing initial voice-centered services into broadband wireless communication systems that provide high-speed, high-quality packet data services based on communication standards such as high speed packet access (HSPA) in 3GPP, long-term evolution (LTE) or evolved universal terrestrial radio access (E-UTRA), LTE-Advanced (LTE-A), LTE-Pro, high rate packet data (HRPD) in 3GPP2, ultra mobile broadband (UMB), and the Institute of Electrical and Electronic Engineers (IEEE) 802.16e.

As a representative example of a broadband wireless communication system, an LTE system adopts an orthogonal frequency division multiplexing (OFDM) scheme for downlink (DL) and a single carrier frequency division multiple access (SC-FDMA) scheme for uplink (UL). UL refers to a radio link through which a UE (or a MS) transmits data or a control signal to a base station (an eNB or a BS), and DL refers to a radio link through which the base station transmits data or a control signal to the UE. In the multiple access schemes as described above, data or control information of each user may be identified by allocating and operating time-frequency resources carrying the data or the control information for each user to prevent interference i.e., maintain orthogonality between the time-frequency resources.

Because a post-LTE communication system, i.e., a 5G communication system, needs to be able to freely reflect various requirements from users, service providers, etc., the 5G communication system is required to support services that simultaneously satisfy the various requirements. Services being considered for 5G communication systems include enhanced mobile broadband (eMBB), massive machine type communication (mMTC), ultra-reliable low-latency communication (URLLC), etc.

Furthermore, although embodiments of the disclosure is described below using an LTE, LTE-A, LTE Pro, or 5G (or NR or next-generation mobile communication) system as an example, the embodiments of the disclosure may be applied to other communication systems having similar technical backgrounds and channel configurations. It will also be understood by a person skilled in the art that embodiments of the disclosure are applicable to other communication systems through some modifications not greatly departing from the scope of the disclosure.

In the following description of the disclosure, when it is determined that detailed descriptions of related known functions or configurations may unnecessarily obscure the subject matter of the disclosure, the detailed descriptions thereof will be omitted. Hereinafter, embodiments of the disclosure are described in detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

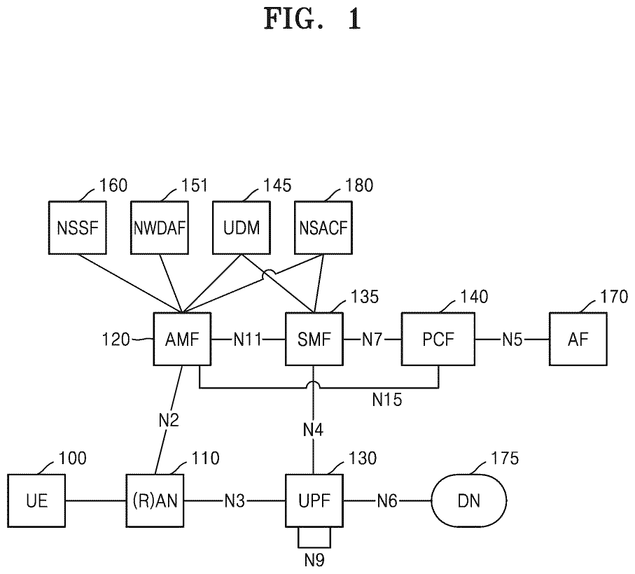

FIG. 1 illustrates an architecture of a 5G system according to an embodiment of the disclosure.

Referring to FIG. 1, a 5G mobile communication network consists of a 5G UE (or terminal) 100, a 5G radio access network (RAN) 110 (including a base station, gNB (5G nodeB), eNB (evolved nodeB), etc.), and a 5G core network. The 5G core network may consist of network functions (NFs), such as access and mobility management function (AMF) 120 that provides a functionality of managing mobility of a UE, a session management function (SMF) 135 that provides a session management functionality, a user plane function (UPF) 130 that plays a data forwarding role, a policy control function (PCF) 140 that provides a policy control functionality, a unified data management (UDM) 145 that provides a functionality of managing data such as subscriber data and policy control data, unified data repository (UDR) that stores data for various NFs such as the UDM 145, etc. The 5G core network may further include NFs, such as a network slice selection function (NSSF) 160, a network data analytic function (NWDAF) 151, an application function (AF) 170, a data network (DN) 175, a network slice admission control function (NSACF) 180, etc.

In the 3GPP system, a conceptual link connecting NFs within the 5G system is defined as a reference point. For example, referring to FIG. 1, reference points included in the 5G system architecture may be as follows.
N1: Reference point between the UE and the AMF
N2: Reference point between the (R)AN and the AMF
N3: Reference point between the (R)AN and the UPF
N4: Reference point between the SMF and the UPF
N5: Reference point between the PCF and the AF
N6: Reference point between the UPF and the DN
N7: Reference point between the SMF and the PCF
N8: Reference point between the UDM and the AMF
N9: Reference point between two core UPFs
N10: Reference point between the UDM and the SMF
N11: Reference point between the AMF and the SMF
N12: Reference point between the AMF and an authentication server function (AUSF)
N13: Reference point between the UDM and the AUSF
N14: Reference point between two AMFs
N15: Reference point between the PCF and the AMF in the case of a non-roaming scenario, or between a PCF within a visited network and the AMF in the case of a roaming scenario

In 5G systems, network slicing refers to a technology and architecture that enables multiple virtualized, independent, logical networks to operate on a single physical network. To satisfy specialized requirements of a service or application, a network operator configures a virtual end-to-end network called a network slice to provide services. In this case, the network slice may be identified by an identifier referred to as single-network slice selection assistance information (S-NSSAI). During a terminal registration procedure (e.g., a UE registration procedure), a network transmits a set of allowed slices (e.g., allowed NSSAI(s)) to a UE, and the UE transmits and receives application data by using a protocol data unit (PDU) session generated via one of the S-NSSAIs (i.e., a network slice). Hereinafter, in an embodiment of the disclosure, the operation of an NF may be understood as operation of orchestration and management (OAM).

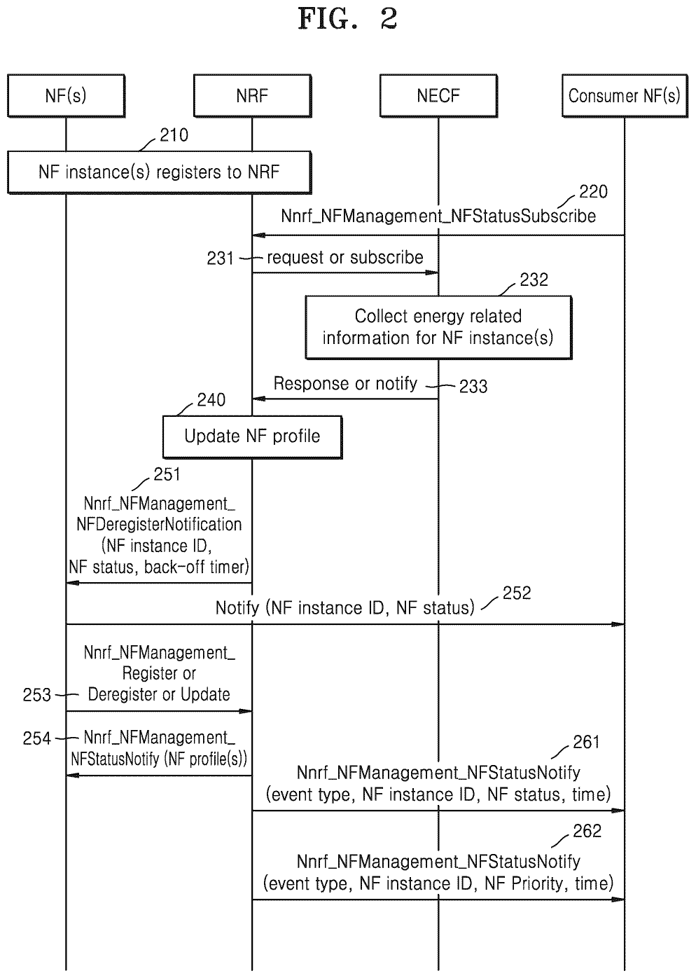

FIG. 2 illustrates a method of updating an NF status or NF priority based on energy information, according to an embodiment of the disclosure.

An NF instance may be associated with a specific NF type. There may be at least one NF instance for a specific NF type (i.e., NF type or NF kind).

The ‘Energy Consumption (or EC)’ of an NF instance may represent energy usage of the NF instance, a percentage value (0% to 100%) of energy usage relative to capacity, energy usage per unit time, a percentage value (0% to 100%) of energy usage per unit time relative to capacity, power consumption, a percentage value (0% to 100%) of power consumption relative to capacity, a percentage value (0% to 100%) of work processed per unit time relative to a total capacity, etc.

The ‘energy efficiency (or EE)’ of an NF instance may represent energy efficiency of the NF instance, an energy efficiency range (e.g., a value indicating a relative energy efficiency representing the energy efficiency range), a percentage value (0% to 100%) of energy efficiency relative to a maximum efficiency, etc.

The ‘Renewable energy’ of an NF instance may represent a percentage value of consumption of the renewable energy (e.g., energy obtained without carbon emissions) in the EC of the NF instance.

In operation 210, an NF (or NF instance) may perform NF registration to a network repository function (NRF). A message from the NF requesting NF registration to the NRF (e.g., an NF registration request message) may include an NF profile. The NF profile may include an NF type (information indicating a specific NF type, e.g., information indicating one of AMF, SMF, or UPF), an NF instance ID (unique identifier information that may identify the NF instance), a fully qualified domain name (FQDN) or internet protocol (IP) address of the NF (an FQDN or IP address which is address information of the NF instance), etc.

The message from the NF requesting the NF registration to the NRF may include an indicator indicating that an NF status update is allowed (hereinafter, an NF status update allow indicator).

The message from the NF requesting the NF registration to the NRF may include an indicator indicating that an NF priority update is allowed (hereinafter, an NF priority update allow indicator).

The NF status update allow indicator or the NF priority update allow indicator may be included in the NF profile.

The NRF may transmit, to the NF, a response message to the registration request.

In operation 220, a consumer NF may transmit, to the NRF, a subscription request for an NF status of NF instance(s). This may be a case where the consumer NF transmits, to the NRF, a subscription request for an NF instance that the consumer NF has selected and is currently using (e.g., the consumer NF calls an NF service offered by the NF instance, etc.).

An NF status subscription request message transmitted by the consumer NF may contain one or more of the following information:

PLMN ID: public land mobile network (PLMN) identifier
target information: It may contain information for specifying a target NF instance to which the consumer NF is to subscribe. For example, it may contain one or more of NF type, NF instance identifier (ID), S-NSSAI, and network slice instance (NSI) ID.
candidate NF profile request indication: When the NF instance corresponding to the target is unavailable (e.g., when the status of the NF instance has been changed from registered to deregistered or suspended), it may contain an indicator requesting transmission of a candidate NF profile.

When the NRF receives the NF status subscription request message from the consumer NF, the NRF may transmit a response message including a callback uniform resource identifier (URI) to the consumer NF.

In operation 231, the NRF may transmit, to a network function energy control function (NECF), a request message for energy related information (or energy related notification) about target NF(s) (e.g., registered NF instances or NF instance(s) which, among the registered NF instances, do not support energy related information (e.g., NF instance(s) or NF(s) not supporting the functionality of providing energy related information about the NF instance(s) to the NRF), or NF instances whose NF profiles include an NF status update allow indicator).

The NECF may be located in an NWDAF, an energy efficiency control function (EECF), an energy monitoring function (EMF), OAM, or another NF.

The request message for energy related information (hereinafter, ‘energy related information request message’) transmitted by the NRF to the NECF may include at least one of the following information:
PLMN ID: PLMN identifier
target information: It may contain information for specifying a target NF instance (a target NF). For example, it may include one or more of NF type, NF instance ID, S-NSSAI, and NSI ID.
request information: It may contain an indicator indicating information being requested. For example, the request information may contain an indicator requesting one or more pieces of information from among EC (information indicating energy consumption of the target NF or energy consumption thereof per unit time), EE (information indicating energy efficiency, which may be information indicating a load relative to EC of the target NF), and renewable energy (information indicating a ratio of renewable energy usage to the EC of the target NF).
reporting information: It may indicate periodic notifications or event-based notifications. When the reporting information indicates a periodic notification, it may also include periodicity information. When the reporting information indicates an event-based notification, it may include threshold information that serves as a criterion for event occurrence.

In operation 232, the NECF may perform an operation for obtaining energy related information (e.g., one or more of information about EE, EC, and renewable energy ratio) about the NF instance(s) corresponding to the target information.

The NECF may obtain the information from OAM or the corresponding NF instance.

In operation 233, the NECF may transmit, to the NRF, energy related information about the NF instance(s) corresponding to the target information as a notification message, based on the energy related information request message (or subscription request message) received in operation 231.

The NECF may transmit a notification message to the NRF periodically or on an event-based basis.

When the NECF periodically transmits a notification message (or when the NECF only provides energy related information about the NF instances), the notification message may include at least one of the following information:
notification correlation ID: It may contain an identifier representing a notification for a subscription.
energy related information: It may contain NF instance ID(s) and one or more of EC, EE, and renewable energy for each NF instance. Alternatively, it may contain S-NSSAI(s) and one or more of EC, EE, and renewable energy for each S-NSSAI. Alternatively, it may contain NSI ID(s) and one or more of EC, EE, and renewable energy for each NSI. When an NSI ID is included, a corresponding S-NSSAI may be included.

When the NECF transmits a notification message in an event-based manner (or when the NECF directly controls the NF status and the like of the NF instances), the notification message may include at least one of the following information:
(when the message received in operation 231 includes information about a threshold for an event-based notification, the NECF may use the threshold, or use thresholds on a slice level (an EC threshold, an EE threshold, or a renewable energy threshold) or thresholds on an NF instance level, which are stored in configuration information):
notification correlation ID: It may contain an identifier representing a notification for a subscription.
Unavailable NF instance ID(s): It may contain NF instance IDs that are unavailable due to energy usage criteria. In this case, time information and reason information may be included together. For example, when EC of an NF instance is higher than a threshold, when EE of the NF instance is lower than a threshold, or when renewable energy of the NF instance is lower than a threshold, the NF instance may be included in the unavailable NF instance ID(s). The Reason information may contain information indicating a corresponding case.
Available NF instance ID(s): It may contain NF instance IDs that have become available due to energy usage criteria. In this case, time information and reason information may be included together. For example, when EC of an NF instance is lower than the threshold, when EE of the NF instance is higher than the threshold, or when renewable energy of the NF instance is higher than the threshold, the NF instance may be included in the available NF instance ID(s). The Reason information may contain information indicating a corresponding case.
NF instance ID(s) to be restricted: It may contain NF instance IDs whose use by NF consumers should be restricted due to energy usage criteria. In this case, time information and reason information may be included together. For example, when EC of an NF instance is higher than the threshold, when EE of the NF instance is higher than the threshold, or when renewable energy of the NF instance is lower than the threshold, the NF instance may be included in the NF instance ID(s) to be restricted. The Reason information may contain information indicating a corresponding case.
NF instance ID(s) to be used: It may contain NF instance IDs whose use by NF consumers should be increased due to energy usage criteria. In this case, time information and reason information may be included together. For example, when EC of an NF instance is lower than the threshold, when EE of the NF instance is lower than the threshold, or when renewable energy of the NF instance is higher than the threshold, the NF instance may be included in the NF instance ID(s) to be used. The Reason information may contain information indicating a corresponding case.

In operation 240, when receiving the message including the energy related information from the NECF, the NRF may update an NF profile (e.g., an NF status or NF priority) for the corresponding NF instance(s).

In an embodiment of the disclosure, the NRF may perform NF status updates only for NF instances whose NF profiles include an NF status update allow indicator.

In an embodiment of the disclosure, the NRF may perform NF priority updates only for NF instances whose NF profiles include an NF priority update allow indicator.

The NRF may update an NF status (registered, deregistered, or suspended) in the following cases.

The NRF may use thresholds on a slice level (EC threshold, EE threshold, or renewable energy threshold) or thresholds on an NF instance level, which are stored in the configuration information.

For example, when the EC of an NF instance is higher than the threshold, the EE of the NF instance is lower than the threshold, or the renewable energy of the NF instance is lower than the threshold, the NRF may update an NF status of the NF instance to deregistered or suspended. For example, when the EC of an NF instance is lower than the threshold, the EE of the NF instance is higher than the threshold, or the renewable energy of the NF instance is higher than the threshold, the NRF may update an NF status of the NF instance from deregistered or suspended to registered.

In an embodiment of the disclosure, when receiving the message including the energy related information from the NECF, the NRF may update an NF priority (information to be used for NF selection, which is a relative priority to other NF instances of the same NF type, with a value in a range of 0 to 65535; a lower value indicates a higher priority).

The NRF may use thresholds on a slice level (EC threshold, EE threshold, or renewable energy threshold) or thresholds on an NF instance level, which are stored in the configuration information.

For example, when the EC of an NF instance is higher than the threshold, the EE of the NF instance is lower than the threshold, or the renewable energy of the NF instance is lower than the threshold, the NRF may update an NF priority of the NF instance to a lower value.

For example, when the EC of an NF instance is lower than the threshold, the EE of the NF instance is higher than the threshold, or the renewable energy of the NF instance is higher than the threshold, the NRF may update an NF priority of the NF instance to a higher value.

For example, the NRF may update an NF priority of NF instance(s), based on relative EC, EE, or renewable energy of the NF instance(s) to other NF instances of the same NF type.

When receiving a message containing unavailable NF instance ID(s) or available NF instance ID(s) from the NECF, the NRF may update an NF profile (e.g., an NF status) for corresponding NF instance(s).

The NRF may update an NF status of NF instances corresponding to NF instance ID(s) included in the unavailable NF instance ID(s) from registered to deregistered or suspended. When a notification message received by the NRF also includes time information, the NRF may update the NF status of the NF instance(s) again to registered after the time corresponding to the time information.

The NRF may update an NF status of NF instances corresponding to NF instance ID(s) included in the available NF instance ID(s) from deregistered or suspended to registered. When the notification message received by the NRF also includes time information, the NRF may update the NF status of the NF instance(s) again to deregistered or suspended after the corresponding time.

When receiving, from the NECF, a message containing NF instance ID(s) to be restricted, the NRF may update an NF profile (e.g., an NF priority) for corresponding NF instance(s).

The NRF may update, to a lower value, an NF priority of NF instances corresponding to NF instance ID(s) included in the NF instance ID(s) to be restricted. For example, the NF priority may be updated to a lower value than those of other NF instance(s) with the same NF type. When the notification message received by the NRF also includes time information, the NRF may update the NF priority of the NF instance(s) again after the corresponding time.

When receiving, from the NECF, a notification message containing NF instance ID(s) to be used, the NRF may update an NF profile (e.g., an NF priority) for corresponding NF instance(s).

The NRF may update, to a higher value, an NF priority of NF instances corresponding to NF instance ID(s) included in the NF instance ID(s) to be used. For example, the NF priority may be updated to a higher value than those of other NF instance(s) with the same NF type. When the notification message received by the NRF includes time information, the NRF may update again the NF priority of the NF instance(s) after the corresponding time.

In operation 251, the NRF may transmit a message (e.g., an NF status change notification message) including information for notifying NF instances whose NF status has been changed from registered to suspended or deregistered (or vice versa) in operation 240 of the NF status changes.

In an embodiment of the disclosure, in case that the NRF receives an NF update message, the NF status change notification message may be transmitted in the form of a response message (e.g., Nnrf_NFManagement_NFUpdate response) to the NF update message.

In an embodiment of the disclosure, the NF status change notification message may be transmitted in the form of a separate notification message (e.g., Nnrf_NFManagement_NFStatusNotify or Nnrf_NFManagement_NFDeregisterNotification request).

The NF status change notification message may include one or more of the following information:
NF status changed indication (may be an event type when Nnrf_NFManagement_NFStatusNotify is used): It may contain an indicator indicating a change in the NF status.
cause, back-off timer: When the NF status is changed to deregistered or suspended, it may contain a cause (e.g., deregistration or suspension due to energy criteria) and additionally a back-off timer.
an NF instance ID and an NF status (registered, deregistered, or suspended). Alternatively, an NF profile containing the NF instance ID and the NF status may be included.

An NF instance (or NF) may update an NF status based on the message received from the NRF. Also, when receiving a back-off timer, the NF instance may not transmit an NF update message (e.g., a heartbeat message) or NF register message during a time corresponding to the back-off timer.

In operation 252, an NF instance that has received the message transmitted in operation 251 and whose NF status has been updated to deregistered or suspended may transmit a message (e.g., an update notification message) for notifying consumer NF(s) using its NF service (e.g., NFs that have recently requested the NF service, or NFs for which a transaction ID exists) of the NF status update.

In case that the NF does not have an address (e.g., a callback URI) of a consumer NF to which the corresponding update notification message is to be transmitted, the NF may obtain the address of the consumer NF via the NRF and transmit the message to the obtained address.

The update notification message may include the following information:
an indicator indicating a change in NF status
cause, back-off timer: When the NF status is changed to deregistered or suspended, this may contain a cause (e.g., deregistration or suspension due to energy criteria) and additionally a back-off timer.
an NF instance ID and an NF status (registered, deregistered, or suspended). Alternatively, an NF profile containing the NF instance ID and the NF status may be included.

When receiving the update notification message from the NF, the consumer NF(s) may determine that an NF instance ID included in the received message is unavailable and reselect a different NF instance.

In operation 253, when receiving the message transmitted in operation 251, an NF may include an NF profile, including an NF status or NF priority contained in the received message, in a message (e.g., a status change response message) transmitted to the NRF.

The status change response message may include an NF register message, an NF deregister message, or an NF update message, and may have the format of a response message (e.g., Nnrf_NFManagement_NFDeregisterNotification response) to the message transmitted in operation 251.

In operation 254, the NRF may transmit a message (e.g., an NF priority change notification message) including information for notifying the NF instances whose NF priority has been changed in operation 240 of the change in NF priority.

In an embodiment of the disclosure, in case that the NRF receives an NF update message, the NF priority change notification message may be transmitted in the form of a response message (Nnrf_NFManagement_NFUpdate response) to the NF update message.

In an embodiment of the disclosure, the NF priority change notification message may be transmitted in the form of a separate notification message (e.g., Nnrf_NFManagement_NFStatusNotify or Nnrf_NFManagement_NFDeregisterNotification request).

The NF priority change notification message may include one or more of the following information:
event type: It may contain an event type indicating an updated NF profile.
NF profile: It may contain an NF profile including an NF instance ID and an updated NF priority. Time information regarding the time when the NF priority is to be applied may be transmitted together.

An NF instance (or NF) may update an NF priority based on the message received from the NRF. Also, in case that the time information is received, the received NF priority can only be used during the corresponding time.

In operation 261, when the NRF has updated an NF status for an NF instance in operation 240, the NRF may transmit a message (e.g., an NF profile (status) update notification message) including information for notifying a consumer NF subscribing to (or using) the NF instance that the NF status for the NF instance has been updated.

The NF profile update notification message may be, for example, Nnrf_NFManagement_NFStatusNotify or Nnrf_NFManagement_NFDeregisterNotification request or another message.

The NF profile update notification message may include one or more of the following information:
event type: When the NF status is updated to deregistered or suspended, it may contain an event type indicating an updated NF profile or a deregistered NF (or suspended NF). When the NF status is updated to registered, an event type indicating an updated NF profile or a registered NF may be included.
NF profile: It may contain an NF profile that includes an NF instance ID and an updated NF status (i.e., deregistered/suspended or registered). When the NF status is changed, time information regarding the time when the changed NF status is to be applied may be transmitted together.
candidate NF profile: When the NF status is updated to deregistered/suspended, it may contain NF profile(s) for candidate NF instances that can be used instead of the NF instance among other NF instances of the same NF type as the NF instance.

When the subscription request message in operation 220 includes a candidate NF profile request indication, the NRF may also include candidate NF profile(s) in the NF profile update notification message.

Consumer NF(s) may receive, from the NRF, a message indicating that the NF status is deregistered, and when there is an NF instance whose status has been changed to deregistered or suspended among NF instances that have been selected and are being used, the consumer NF(s) may determine that the corresponding NF instance ID contained in the received message is unavailable and reselect a different NF instance.

When the received information includes time information, the consumer NF may determine that the NF instance ID included in the received message is unavailable during the corresponding time and reselect and use the existing NF instance ID after that time.

In operation 262, when the NRF has updated an NF priority for an NF instance in operation 240, the NRF may transmit a message (e.g., an NF profile (priority) update notification message) including information for notifying a consumer NF subscribing to (or using) the NF instance that the NF priority for the NF instance has been updated.

The NF profile update notification message may be, for example, Nnrf_NFManagement_NFStatusNotify or Nnrf_NFManagement_NFDeregisterNotification request or another message.

The NF profile update notification message may include one or more of the following information:
event type: It may contain an event type indicating an updated NF profile.
NF profile: It may contain an NF profile including an NF instance ID and an updated NF priority. Time information about the time when the changed NF priority is to be applied may be transmitted together.
candidate NF profile: When the NF priority is updated to a lower value, it may contain NF profile(s) for candidate NF instances that can be used instead of the NF instance among other NF instances of the same NF type as the NF instance.

When the subscription request message in operation 220 includes a candidate NF profile request indication, the NRF may also include candidate NF profile(s) in the NF profile update notification message.

Consumer NF(s) may receive an NF priority from the NRF, and when there is an NF instance with a changed NF priority among NF instances that have been selected and are being used, reselect, based on the updated NF priority, a different NF instance from an NF type of the NF instances that have been selected and is being used.

When the received information includes time information, the consumer NF may determine that the NF priority for the NF instance ID contained in the received message is applied during the corresponding time, and perform NF selection by reusing the existing NF priority for the existing NF instance ID after that time.

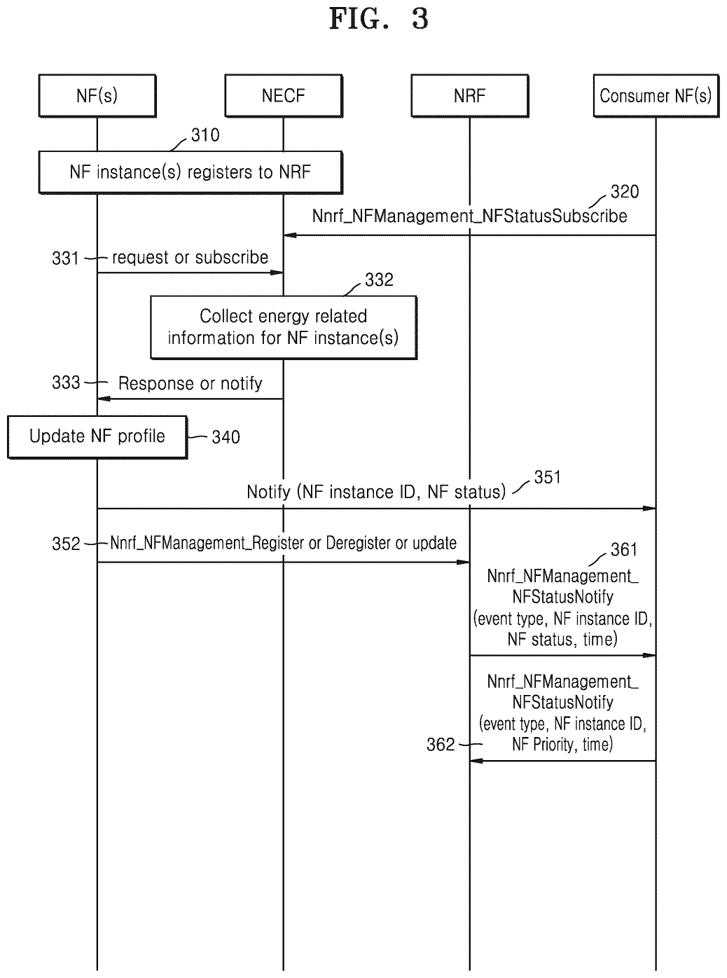

FIG. 3 illustrates an NF-based method of updating an NF status based on energy information, according to an embodiment of the disclosure.

In an embodiment of the disclosure, an NF instance may be associated with a specific NF type. There may be at least one NF instance for a specific NF type (i.e., NF type or NF kind).

The EC of an NF instance may represent energy usage of the NF instance, a percentage value (0% to 100%) of energy usage relative to capacity, energy usage per unit time, a percentage value (0% to 100%) of energy usage per unit time relative to capacity, power consumption, a percentage value (0% to 100%) of power consumption relative to capacity, a percentage value (0% to 100%) of work processed per unit time relative to a total capacity, etc.

The ‘EE’ of an NF instance may represent energy efficiency of the NF instance, an energy efficiency range (e.g., a value indicating a relative energy efficiency representing the energy efficiency range), a percentage value (0% to 100%) of energy efficiency relative to a maximum efficiency, etc.

The ‘renewable energy’ of an NF instance may represent a percentage value of consumption of the renewable energy (e.g., energy obtained without carbon emissions) in the EC of the NF instance.

In operation 310, an NF (or NF instance) may perform NF registration to an NRF. A message from the NF requesting NF registration to the NRF (e.g., an NF registration request message) may include an NF profile. The NF profile may include an NF type (information indicating a specific NF type, e.g., information indicating one of AMF, SMF, or UPF), an NF instance ID (unique identifier information that may identify the NF instance), a fully qualified domain name (FQDN) or Internet Protocol (IP) address of the NF (an FQDN or IP address which is address information of the NF instance), etc.

The NRF may transmit, to the NF, a response message to the registration request.

In operation 320, a consumer NF may transmit, to the NRF, a subscription request for an NF status of NF instance(s). This may be a case where the consumer NF transmits, to the NRF, a subscription request for an NF instance that the consumer NF has selected and is currently using (e.g., the consumer NF calls an NF service offered by the NF instance).

An NF status subscription request message transmitted by the consumer NF may contain one or more of the following information:
PLMN ID: PLMN identifier
target information: It may contain information for specifying a target NF instance to which the consumer NF is to subscribe. For example, one or more of NF type, NF instance ID, S-NSSAI, and NSI ID may be included.
candidate NF profile request indication: When the NF instance corresponding to the target is unavailable (e.g., when the status of the NF instance has been changed from registered to deregistered or suspended), it may contain an indicator requesting transmission of a candidate NF profile.

When the NRF receives the NF status subscription request message from the consumer NF, the NRF may transmit a response message including a callback URI to the consumer NF.

In operation 331, the NF instance may transmit, to an NECF, a request message for energy related information (or energy related notification) about the NF instance (or NF instances having the same NF type as the NF instance).

The NECF may be located in an NWDAF, an EECF, an EMF, OAM, or another NF.

The energy related information request message transmitted by the NF to the NECF may include the following information:
PLMN ID: PLMN identifier
target information: It may contain information for specifying a target NF instance (a target NF). For example, one or more of NF type, NF instance ID, S-NSSAI, and NSI ID may be included.
request information: It may contain an indicator indicating information being requested. For example, the request information may contain an indicator requesting one or more pieces of information from among EC (information indicating energy consumption of the target NF or energy consumption thereof per unit time), EE (information indicating energy efficiency, which may be information indicating a load relative to EC of the target NF), and renewable energy (information indicating a ratio of renewable energy usage to the EC of the target NF).
reporting information: It may indicate periodic notifications or event-based notifications. When the reporting information indicates a periodic notification, it may also include periodicity information.

When the reporting information indicates an event-based notification, it may include threshold information that serves as a criterion for event occurrence.

In operation 332, the NECF may perform an operation for obtaining energy related information (e.g., one or more of information about EE, EC, and renewable energy ratio) about the NF instance(s) corresponding to the target information.

The NECF may obtain the information from OAM or the corresponding NF instance.

In operation 333, the NECF may transmit, to the NF, energy related information about the NF instance(s) corresponding to the target information as a notification message, based on the energy related information request message (or subscription request message) received in operation 331.

The NECF may transmit a notification message to the NF periodically or on an event-based basis.

When the NECF periodically transmits a notification message (or when the NECF only provides energy related information about the NF instances), the notification message may include at least one of the following information:
notification correlation ID: It may contain an identifier representing a notification for a subscription.
energy related information: It may contain NF instance ID(s) and one or more of EC, EE, and renewable energy for each NF instance. Alternatively, it may contain S-NSSAI(s) and one or more of EC, EE, and renewable energy for each S-NSSAI. Alternatively, it may contain NSI ID(s) and one or more of EC, EE, and renewable energy for each NSI. When an NSI ID is included, a corresponding S-NSSAI may be included.

When the NECF transmits a notification message in an event-based manner (or when the NECF directly controls the NF status and the like of the NF instances), the notification message may include at least one of the following information:
(when the message received in operation 331 includes information about a threshold for an event-based notification, the NECF may use the threshold, or use thresholds on a slice level (an EC threshold, an EE threshold, or a renewable energy threshold) or thresholds on an NF instance level, which are stored in the configuration information):
notification correlation ID: It may contain an identifier representing a notification for a subscription.
Unavailable NF instance ID(s): It may contain NF instance IDs that are unavailable due to energy usage criteria. In this case, time information and reason information may be included together. For example, when EC of an NF instance is higher than a threshold, when EE of the NF instance is lower than a threshold, or when renewable energy of the NF instance is lower than a threshold, the NF instance may be included in the unavailable NF instance ID(s). The Reason information may contain information indicating a corresponding case.
Available NF instance ID(s): It may contain NF instance IDs that have become available due to energy usage criteria. In this case, time information and reason information may be included together. For example, when EC of an NF instance is lower than the threshold, when EE of the NF instance is higher than the threshold, or when renewable energy of the NF instance is higher than the threshold, the NF instance may be included in the available NF instance ID(s). The Reason information may contain information indicating a corresponding case.
NF instance ID(s) to be restricted: It may contain NF instance IDs whose use by NF consumers should be restricted due to energy usage criteria. In this case, time information and reason information may be included together. For example, when EC of an NF instance is higher than the threshold, when EE of the NF instance is higher than the threshold, or when renewable energy of the NF instance is lower than the threshold, the NF instance may be included in the NF instance ID(s) to be restricted. The Reason information may contain information indicating a corresponding case.
NF instance ID(s) to be used: It may contain NF instance IDs whose use by NF consumers should be increased due to energy usage criteria. In this case, time information and reason information may be included together. For example, when EC of an NF instance is lower than the threshold, when EE of the NF instance is lower than the threshold, or when renewable energy of the NF instance is higher than the threshold, the NF instance may be included in the NF instance ID(s) to be used. The Reason information may contain information indicating a corresponding case.

In operation 340, when receiving the message including the energy related information from the NECF, the NF may update an NF profile (e.g., an NF status or NF priority) for the corresponding NF instance(s).

The NF may update an NF status (registered, deregistered, or suspended) in the following cases.

The NF may use thresholds on a slice level (EC threshold, EE threshold, or renewable energy threshold) or thresholds on an NF instance level, which are stored in the configuration information.

For example, when the EC of an NF instance is higher than the threshold, the EE of the NF instance is lower than the threshold, or the renewable energy of the NF instance is lower than the threshold, the NF may update an NF status of the NF instance to deregistered or suspended. For example, when the EC of an NF instance is lower than the threshold, the EE of the NF instance is higher than the threshold, or the renewable energy of the NF instance is higher than the threshold, the NF may update an NF status of the NF instance from deregistered or suspended to registered.

In an embodiment of the disclosure, when receiving the message including the energy related information from the NECF, the NF may update an NF priority (information to be used for NF selection, which is a relative priority to other NF instances of the same NF type, with a value in a range of 0 to 65535; a lower value indicates a higher priority).

The NF may use thresholds on a slice level (EC threshold, EE threshold, or renewable energy threshold), or thresholds on an NF instance level, which are stored in the configuration information.

For example, when the EC of an NF instance is higher than the threshold, the EE of the NF instance is lower than the threshold, or the renewable energy of the NF instance is lower than the threshold, the NF may update an NF priority of the NF instance to a lower value.

For example, when the EC of an NF instance is lower than the threshold, the EE of the NF instance is higher than the threshold, or the renewable energy of the NF instance is higher than the threshold, the NF may update an NF priority of the NF instance to a higher value.

For example, the NF may update an NF priority of NF instance(s), based on relative EC, EE, or renewable energy of the NF instance(s) to other NF instances of the same NF type.

When receiving a message containing unavailable NF instance ID(s) or available NF instance ID(s) from the NECF, the NF may update an NF profile (e.g., an NF status) for corresponding NF instance(s).

The NF may update an NF status of NF instances corresponding to NF instance ID(s) included in the unavailable NF instance ID(s) from registered to deregistered or suspended. When a notification message received by the NF also includes time information, the NF may update the NF status of the NF instance(s) again to registered after the time corresponding to the time information.

The NF may update an NF status of NF instances corresponding to NF instance ID(s) included in the available NF instance ID(s) from deregistered or suspended to registered. When the notification message received by the NF includes time information, the NF may update the NF status of the NF instance(s) again to deregistered or suspended after the corresponding time.

When receiving, from the NECF, a message containing NF instance ID(s) to be restricted, the NF may update an NF profile (e.g., an NF priority) for corresponding NF instance(s).

The NF may update, to a lower value, an NF priority of NF instances corresponding to NF instance ID(s) included in the NF instance ID(s) to be restricted. For example, the NF priority may be updated to a lower value than those of other NF instance(s) with the same NF type. When a notification message received by the NF also includes time information, the NF may update the NF priority of the NF instance(s) again after the corresponding time.

When receiving, from the NECF, a message containing NF instance ID(s) to be used, the NF may update an NF profile (e.g., an NF priority) for corresponding NF instance(s).

The NF may update, to a higher value, an NF priority of NF instances corresponding to NF instance ID(s) included in the NF instance ID(s) to be used. For example, the NF priority may be updated to a higher value than those of other NF instance(s) with the same NF type. When a notification message received by the NF also includes time information, the NF may update the NF priority of the NF instance(s) again after the corresponding time.

In operation 351, an NF instance that has received the message transmitted in operation 333 and whose NF status has been updated to deregistered or suspended may transmit a message (e.g., an update notification message) for notifying consumer NF(s) using its NF service (e.g., NFs that have recently requested the NF service, or NFs for which a transaction ID exists) of the NF status update.

In case that the NF does not have an address (e.g., a callback URI) of a consumer NF to which the corresponding update notification message is to be transmitted, the NF may obtain the address of the consumer NF via the NRF and transmit the message to the obtained address.

The update notification message may include the following information:
an indicator indicating a change in NF status
cause, back-off timer: When the NF status is changed to deregistered or suspended, it may contain a cause (e.g., deregistration or suspension due to energy criteria) and additionally a back-off timer.
an NF instance ID and an NF status (registered, deregistered, or suspended). Alternatively, an NF profile containing the NF instance ID and the NF status may be included.

When receiving the update notification message from the NF, the consumer NF(s) may determine that an NF instance ID included in the received message is unavailable and reselect a different NF instance.

In operation 352, when receiving the message transmitted in operation 333, the NF may include an NF profile, including an NF status or NF priority contained in the received message, in a message (e.g., a status change notification message) transmitted to the NRF. The status change notification message may include an NF register message, an NF deregister message, or an NF update message.

In operation 361, in case that the NRF has updated the NF status for the NF instance due to the message (the status change notification message) received in operation 352, the NRF may transmit a message (e.g., an NF profile (status) update notification message) including information for notifying a consumer NF subscribing to (or using) the NF instance that the NF status for the NF instance has been updated.

The NF profile update notification message may be, for example, Nnrf_NFManagement_NFStatusNotify or Nnrf_NFManagement_NFDeregisterNotification request or another message.

The NF profile update notification message may include one or more of the following information:
event type: When the NF status is updated to deregistered or suspended, it may contain an event type indicating an updated NF profile or a deregistered NF (or suspended NF). When the NF status is updated to registered, an event type indicating an updated NF profile or a registered NF may be included.
NF profile: It may contain an NF profile that includes an NF instance ID and an updated NF status (i.e., deregistered/suspended or registered). When the NF status is changed, time information regarding the time when the changed NF status is to be applied may be transmitted together.
candidate NF profile: When the NF status is updated to deregistered/suspended, it may contain NF profile(s) for candidate NF instances that can be used instead of the NF instance among other NF instances of the same NF type as the NF instance.

When the subscription request message in operation 320 includes a candidate NF profile request indication, the NRF may also include candidate NF profile(s) in the NF profile update notification message.

Consumer NF(s) may receive, from the NRF, a message indicating that the NF status is deregistered, and when there is an NF instance whose status has been changed to deregistered or suspended among NF instances that have been selected and are being used, the consumer NF(s) may determine that the corresponding NF instance ID contained in the received message is unavailable and reselect a different NF instance.

When the received information includes time information, the consumer NF may determine that the NF instance ID included in the received message is unavailable during the corresponding time and reselect and use the existing NF instance ID after that time.

In operation 362, in case that the NRF has updated the NF priority for the NF instance due to the message (the status change notification message) received in operation 352, the NRF may transmit a message (e.g., an NF profile (status) update notification message) including information for notifying a consumer NF subscribing to (or using) the NF instance that the NF priority for the NF instance has been updated.

The NF profile update notification message may be, for example, Nnrf_NFManagement_NFStatusNotify or Nnrf_NFManagement_NFDeregisterNotification request or another message.

The NF profile update notification message may include one or more of the following information:
event type: It may contain an event type indicating an updated NF profile.
NF profile: It may contain an NF profile including an NF instance ID and an updated NF priority. Time information about the time when the changed NF priority is to be applied may be transmitted together.
candidate NF profile: When the NF priority is updated to a lower value, it may contain NF profile(s) for candidate NF instances that can be used instead of the NF instance among other NF instances of the same NF type as the NF instance.

When the subscription request message in operation 320 includes a candidate NF profile request indication, the NRF may also include candidate NF profile(s) in the NF profile update notification message.

Consumer NF(s) may receive an NF priority from the NRF, and when there is an NF instance with a changed NF priority among NF instances that have been selected and are being used, reselect, based on the updated NF priority, a different NF instance among an NF type of the NF instances that have been selected and are being used.

When the received information includes time information, the consumer NF may determine that the NF priority for the NF instance ID contained in the received message is applied during the corresponding time, and perform NF selection by reusing the existing NF priority for the existing NF instance ID after the corresponding time.

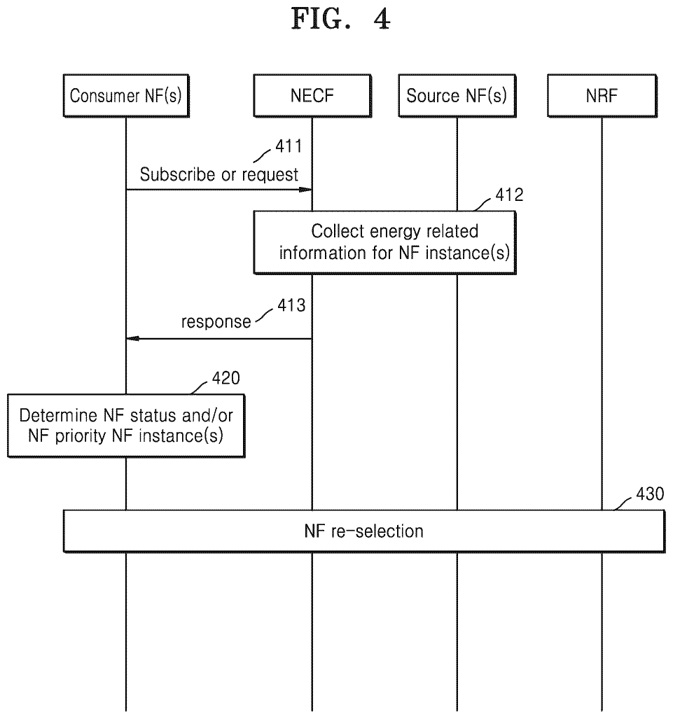

FIG. 4 illustrates a consumer NF based method of determining an NF status or NF priority based on energy information, according to an embodiment of the disclosure.

In operation 411, the consumer NF may transmit, to an NECF, a request message for energy related information (or energy related notification) about NF instance(s) (e.g., an NF instance that the consumer NF has selected and is currently using (e.g., the consumer NF calls an NF service offered by the NF instance, etc.) or NF instances included in an NF type that the consumer NF has selected and is currently using (or NF instances having the same NF type as the NF instance)).

The NECF may be located in an NWDAF, an energy efficiency control function (EECF), an energy monitoring function (EMF), OAM, or another NF.

The energy related information request message transmitted by the consumer NF to the NECF may include the following information:
PLMN ID: PLMN identifier
target information: It may contain information for specifying a target NF instance (a target NF). For example, one or more of NF type, NF instance ID, S-NSSAI, and NSI ID may be included.
request information: It may contain an indicator indicating information being requested. For example, the request information may contain an indicator requesting one or more pieces of information from among EC (information indicating energy consumption of the target NF or energy consumption thereof per unit time), EE (information indicating energy efficiency, which may be information indicating a load relative to EC of the target NF), and renewable energy (information indicating a ratio of renewable energy usage to the EC of the target NF).
reporting information: It may indicate periodic notifications or event-based notifications. When the reporting information indicates a periodic notification, it may also include periodicity information.

When the reporting information indicates an event-based notification, it may include threshold information that serves as a criterion for event occurrence.

In operation 412, the NECF may perform an operation for obtaining energy related information (e.g., one or more of information about EE, EC, and renewable energy ratio) about the NF instance(s) corresponding to the target information.

The NECF may obtain the information from OAM or the corresponding NF instance.

In operation 413, the NECF may transmit, to the consumer NF, energy related information about the NF instance(s) corresponding to the target information as a notification message, based on the energy related information request message (or subscription request message) received in operation 412.

The NECF may transmit a notification message to the consumer NF periodically or on an event-based basis.

When the NECF periodically transmits a notification message (or when the NECF only provides energy related information about the NF instances), the notification message may include at least one of the following information:
notification correlation ID: It may contain an identifier representing a notification for a subscription.
energy related information: It may contain NF instance ID(s) and one or more of EC, EE, and renewable energy for each NF instance. Alternatively, it may contain S-NSSAI(s) and one or more of EC, EE, and renewable energy for each S-NSSAI. Alternatively, it may contain NSI ID(s) and one or more of EC, EE, and renewable energy for each NSI. When an NSI ID is included, a corresponding S-NSSAI may be included.

When the NECF transmits a notification message in an event-based manner (or when the NECF directly controls the NF status and the like of NF instances), the notification message may include at least one of the following information:
(when the message received in operation 411 includes information about a threshold for an event-based notification, the NECF may use the threshold, or use thresholds on a slice level (an EC threshold, an EE threshold, or a renewable energy threshold) or thresholds on an NF instance level, which are stored in the configuration information):
notification correlation ID: It may contain an identifier representing a notification for a subscription.
Unavailable NF instance ID(s): It may contain NF instance IDs that are unavailable due to energy usage criteria. In this case, time information and reason information may be included together. For example, when EC of an NF instance is higher than a threshold, when EE of the NF instance is lower than a threshold, or when renewable energy of the NF instance is lower than a threshold, the NF instance may be included in the unavailable NF instance ID(s). The reason information may contain information indicating a corresponding case.
Available NF instance ID(s): It may contain NF instance IDs that have become available due to energy usage criteria. In this case, time information and reason information may be included together. For example, when EC of an NF instance is lower than the threshold, when EE of the NF instance is higher than the threshold, or when renewable energy of the NF instance is higher than the threshold, the NF instance may be included in the available NF instance ID(s). The Reason information may contain information indicating a corresponding case.
NF instance ID(s) to be restricted: It may contain NF instance IDs whose use by NF consumers should be restricted due to energy usage criteria. In this case, time information and reason information may be included together. For example, when EC of an NF instance is higher than the threshold, when EE of the NF instance is higher than the threshold, or when renewable energy of the NF instance is lower than the threshold, the NF instance may be included in the NF instance ID(s) to be restricted. The reason information may contain information indicating a corresponding case.
NF instance ID(s) to be used: It may contain NF instance IDs whose use by NF consumers should be increased due to energy usage criteria. In this case, time information and reason information may be included together. For example, when EC of an NF instance is lower than the threshold, when EE of the NF instance is lower than the threshold, or when renewable energy of the NF instance is higher than the threshold, the NF instance may be included in the NF instance ID(s) to be used. The Reason information may contain information indicating a corresponding case.

In operation 420, when receiving the message including the energy related information from the NECF, the consumer NF may update an NF profile (e.g., an NF status and/or an NF priority) for the corresponding NF instance(s).

The consumer NF may update an NF status (registered, deregistered, or suspended) in the following cases.

The consumer NF may use thresholds on a slice level (EC threshold, EE threshold, or renewable energy threshold) or thresholds on an NF instance level, which are stored in the configuration information.

For example, when the EC of an NF instance is higher than the threshold, the EE of the NF instance is lower than the threshold, or the renewable energy of the NF instance is lower than the threshold, the consumer NF may update an NF status of the NF instance to deregistered or suspended. For example, when the EC of an NF instance is lower than the threshold, the EE of the NF instance is higher than the threshold, or the renewable energy of the NF instance is higher than the threshold, the consumer NF may update an NF status of the NF instance from deregistered or suspended to registered.

In an embodiment of the disclosure, when receiving the message including the energy related information from the NECF, the consumer NF may update an NF priority (information to be used for NF selection, which is a relative priority to other NF instances of the same NF type, with a value in a range of 0 to 65535; a lower value indicates a higher priority).

The consumer NF may use thresholds on a slice level (EC threshold, EE threshold, or renewable energy threshold) or thresholds on an NF instance level, which are stored in the configuration information.

For example, when the EC of an NF instance is higher than the threshold, the EE of the NF instance is lower than the threshold, or the renewable energy of the NF instance is lower than the threshold, the consumer NF may update an NF priority of the NF instance to a lower value.

For example, when the EC of an NF instance is lower than the threshold, the EE of the NF instance is higher than the threshold, or the renewable energy of the NF instance is higher than the threshold, the consumer NF may update an NF priority of the NF instance to a higher value.

For example, the consumer NF may update an NF priority of NF instance(s), based on relative EC, EE, or renewable energy of the NF instance(s) to other NF instances of the same NF type.

When receiving a message containing unavailable NF instance ID(s) or available NF instance ID(s) from the NECF, the consumer NF may update an NF profile (e.g., an NF status) for corresponding NF instance(s).

The consumer NF may update an NF status of NF instances corresponding to NF instance ID(s) included in the unavailable NF instance ID(s) from registered to deregistered or suspended. When a notification message received by the consumer NF also includes time information, the consumer NF may update the NF status of the NF instance(s) again to registered after the time corresponding to the time information.

The consumer NF may update an NF status of NF instances corresponding to NF instance ID(s) included in the available NF instance ID(s) from deregistered or suspended to registered. When the notification message received by the consumer NF also includes time information, the consumer NF may update the NF status of the NF instance(s) again to deregistered or suspended after the corresponding time.

When receiving, from the NECF, a message containing NF instance ID(s) to be restricted, the consumer NF may update an NF profile (e.g., an NF priority) for corresponding NF instance(s).

The consumer NF may update, to a lower value, an NF priority of NF instances corresponding to NF instance ID(s) included in the NF instance ID(s) to be restricted. For example, the NF priority may be updated to a lower value than those of other NF instance(s) with the same NF type. When a notification message received by the consumer NF also includes time information, the NRF may update the NF priority of the NF instance(s) again after the corresponding time.

When receiving, from the NECF, a message containing NF instance ID(s) to be used, the consumer NF may update an NF profile (e.g., an NF priority) for corresponding NF instance(s).

The consumer NF may update, to a higher value, an NF priority of NF instances corresponding to NF instance ID(s) included in the NF instance ID(s) to be used. For example, the NF priority may be updated to a higher value than those of other NF instance(s) with the same NF type. When a notification message received by the consumer NF also includes time information, the NRF may update the NF priority of the NF instance(s) again after the corresponding time.

In operation 430, when there is an NF instance whose status has been changed to deregistered or suspended among NF instances that the consumer NF(s) have selected and are currently using, the consumer NF(s) may determine that the corresponding NF instance ID contained in the received message is unavailable and reselect a different NF instance.

When the information received by the consumer NF includes time information, the consumer NF may determine that the NF instance ID included in the received message is unavailable during the corresponding time and reselect and use the existing NF instance ID after that time.

When there is an NF instance with a changed NF priority among NF instances that have been selected and are being used, the consumer NF(s) may reselect, based on the updated NF priority, a different NF instance from an NF type of the NF instances that have been selected and are being used.

When the information received by the consumer NF includes time information, the consumer NF may determine that the NF priority for the NF instance ID contained in the received message is applied during the corresponding time, and perform NF selection by reusing the existing NF priority for the existing NF instance ID after that time.

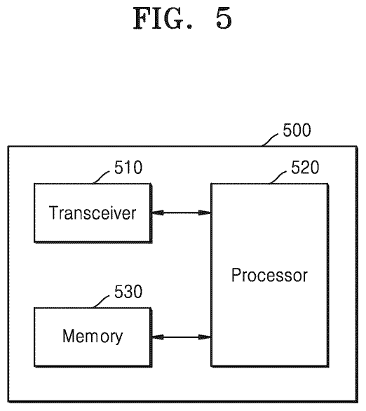

FIG. 5 is a diagram illustrating a network entity 500 according to an embodiment of the disclosure.

In an embodiment of the disclosure, the network entity 500 may correspond to the NF(s), NRF, NECF, consumer NF(s), NSSF, NWDAF, UDM, NSACF, AMF, SMF, PCF, AF, UE, RAN, AN, UPF, or DN illustrated in FIG. 1, 2, 3, or 4.

Referring to FIG. 5, the network entity 500 may include a transceiver 510, a processor 520, and a memory 530. In accordance with the communication method of the network entity 500 described above, the transceiver 510, the processor 520, and the memory 530 of the network entity 500 may operate. However, the components of the network entity 500 are not limited to the above example. For example, the network entity 500 may include more or fewer components than those described above. In an embodiment of the disclosure, the transceiver 510, the processor 520, and the memory 530 may be implemented in the form of a single chip. In addition, the processor 520 may include one or more processors.

The transceiver 510 collectively refers to a receiver of the network entity 500 and a transmitter of the network entity 500, and may transmit and receive signals to and from a UE or base station. The signals transmitted to and received from the UE or base station may include control information and data.

Furthermore, the transceiver 510 may perform functions for transmitting and receiving signals via a radio channel. For example, the transceiver 510 may receive a signal via a radio channel and output the signal to the processor 520 and transmit a signal output from the processor 520 via a radio channel.

The memory 530 may store programs and data necessary for operations of the network entity 500. Furthermore, the memory 530 may store control information or data included in signals obtained by the network entity 500. The memory 530 may include storage media such as read-only memory (ROM), random access memory (RAM), hard disks, compact disc ROM (CD-ROM), and digital versatile discs (DVDs), or a combination of the storage media. Furthermore, the memory 530 may not exist separately but may be included in the processor 520. The memory 530 may consist of volatile memory, non-volatile memory, or a combination of volatile memory and non-volatile memory. In addition, the memory 530 may provide stored data according to a request from the processor 520.

The processor 520 may control a series of processes so that the network entity 500 may operate according to the embodiment of the disclosure. For example, the processor 520 may receive control signals and data signals via the transceiver 510 and process the received control signals and data signals. The processor 520 may transmit the processed control signals and data signals via the transceiver 510. Furthermore, the processor 520 may write data to and read data from the memory 530. The processor 520 may perform functions of a protocol stack required by a communication standard. For this purpose, the processor 520 may include at least one processor or microprocessor. In an embodiment of the disclosure, a portion of the transceiver 510 or the processor 520 may be referred to as a communication processor (CP).

The above description of the disclosure is provided for illustration, and it will be understood by those of ordinary skill in the art that changes in form and details may be readily made therein without departing from technical idea or essential characteristics of the disclosure. Therefore, it should be understood that the above-described embodiments of the disclosure and all aspects thereof are merely examples and are not limiting. For example, each component defined as an integrated component may be implemented in a distributed fashion, and likewise, components defined as separate components may be implemented in an integrated form.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a consumer network function (NF) in a wireless communication system, the method comprising:
transmitting, to a network function energy control function (NECF), a request message for energy related information about at least one NF instance;
receiving, from the NECF, a response message including the energy related information about the at least one NF instance corresponding to a target NF; and
performing energy-aware NF selection based on the received energy related information.

2. The method of claim 1, wherein the NECF is comprised in a network data analytic function (NWDAF).

3. The method of claim 1, wherein the at least one NF instance includes NF instances included in an NF type that the consumer NF has selected and currently using.

4. The method of claim 1, wherein the request message for energy related information includes target NF information and request identifier.

5. The method of claim 1, wherein the response message is received periodically.

6. The method of claim 5, wherein the response message includes at least one of energy efficiency (EE), energy consumption (EC), or renewable energy ratio.

7. A method performed by a network function energy control function (NECF) in a wireless communication system, the method comprising:
receiving, from a consumer network function (NF), a request message for energy related information about at least one NF instance;
collecting the energy related information about the at least one NF instance based on the request message; and
transmitting, to the consumer NF, a response message including the energy related information about the at least one NF instance corresponding to a target NF.

8. The method of claim 7, wherein the NECF is comprised in a network data analytic function (NWDAF).

9. The method of claim 7, wherein the at least one NF instance includes NF instances included in an NF type that the consumer NF has selected and currently using.

10. The method of claim 7, wherein the request message for energy related information includes target NF information and request identifier.

11. The method of claim 7, wherein the energy related information includes at least one of energy efficiency (EE), energy consumption (EC), or renewable energy ratio.

12. The method of claim 7, wherein the energy related information is collected from an OAM or corresponding NF instance.

13. The method of claim 7, wherein the response message is transmitted periodically.
